(19) United States
(12) Patent Application Publication
(10) Pub. No.: US 2026/0233382 A1
(43) Pub. Date: Aug. 13, 2026

(54) INDUSTRIAL ROBOT

(71) Applicant: autonox Robotics GmbH, Willstätt (DE)

(72) Inventor: Guillaume HAAS, Gerstheim (FR)

(73) Assignee: autonox Robotics GmbH, Willstätt (DE)

(21) Appl. No.: 19/157,453

(22) PCT Filed: Mar. 4, 2024
(86) PCT No.: PCT/DE2024/100176

§ 371 Date: Aug. 18, 2025

(30) Foreign Application Priority Data
Mar. 7, 2023 (DE) 10 2023 105 555.0

(51) Int. Cl. B25J 9/10; B25J 9/00; B25J 9/04

(52) U.S. Cl. CPC B25J 9/102; B25J 9/0036; B25J 9/047

(57) ABSTRACT

An industrial robot with serial or parallel kinematics includes a robot base, at least one robot arm with arm drive and an effector holder receiving an effector. The at least one robot arm is designed to move the effector holder relative to the robot base in at least two dimensions in space. The industrial robot has at least one first hand axis which moves an effector arranged on the effector holder with respect to a first geometric axis. The first hand axis includes a first hand axis motor and a first hand axis gear. The first hand axis gear has a first gear stage coupled to the first hand axis motor, which includes a first planetary gear, and a second gear stage coupled to the first gear stage, which includes a first bevel gear.

The invention relates to an industrial robot with serial kinematics or parallel kinematics, which comprises a robot base, at least one robot arm with arm drive, and an effector holder receiving an effector, wherein the at least one robot arm is designed to move the effector holder relative to the robot base in at least two dimensions in space.

Such industrial robots with serial kinematics or parallel kinematics are used to position and move an effector in space. They are equipped with a robot base that is stationary or mounted on a movable platform and an effector holder for receiving an effector. A gripper, a tool, or a machine element, for example, is used as the effector. The movement of the effector holder relative to the robot base is achieved by means of at least one robot arm equipped with an arm drive. An industrial robot with serial kinematics is, for example, an articulated arm robot or a Scara-robot. The latter is also referred to as a horizontal articulated arm robot. The structure of an industrial robot with serial kinematics is similar to that of a human arm. An industrial robot with parallel kinematics has two, three, or more robot arms, which are attached at one end to the robot base and at the other end to a carrier element, which holds the effector holder. The carrier element can also be referred to as a tool carrier or platform. The coordinated movement of the driven robot arms allows an effector mounted on the effector holder to be moved precisely in several dimensions in space. The robot arms of the parallel kinematics cause a spatial parallelogram guidance of the effector holder. All arms contribute simultaneously and thus parallel to the movement of the carrier element.

The positioning of the effector holder with an effector attached to it is carried out in space by means of at least one robot arm. Movement of the effector holder relative to the robot arm and movement of the effector or parts of the effector relative to the effector holder is carried out by means of at least one hand axis. This enables, for example, rotation of the effector or the opening and closing of an effector designed as a gripper. If the at least one robot arm moves the effector holder in relation to three axes, the corresponding robot arm axes are designated as 1. axis, 2. axis, and 3. axis. The hand axes, which move an effector arranged on the effector holder, are designated as 4. axis, 5. axis, and 6. axis. In this case, the industrial robot is equipped with six axes, three of which are designed as hand axes. The industrial robot may have only four or five axes. In this case, either the number of axes of the at least one robot arm is reduced or the number of hand axes is reduced.

Each hand axis is equipped with a hand axis motor and a hand axis gear. The hand axis motor and the hand axis gear ensure that an effector mounted on the effector holder moves in relation to a geometric axis. A geometric axis is a mathematical straight line. If several hand axes are provided, the associated geometric axes are typically at an angle to each other, for example at an angle of 90°.

The hand axis motors are preferably arranged directly on or close to the effector holder so that the distance to the effector is shortened and losses in power transmission and torque transmission are minimized. The hand axis motors and hand axis gears must be as compact as possible, as there is only limited space available in the immediate vicinity of the effector. In addition, the hand axis gears should be as light as possible, have low backlash, low friction, good efficiency, and a suitable transmission ratio.

The object of the invention is to provide an industrial robot in which the at least one hand axis requires little space, has low backlash, high efficiency, and a transmission ratio suitable for the application.

This object is solved by an industrial robot with the features of claim 1. The industrial robot is characterized in that the at least one hand axis has a hand axis gear with a first gear stage and a second gear stage, wherein the first gear stage comprises a planetary gear and the second gear stage comprises a bevel gear. The planetary gear is coupled to the hand axis motor. The bevel gear is coupled to the planetary gear. The effector holder is coupled to the bevel gear. Thanks to the planetary gear, a transmission ratio between the rotational speed of the hand axis motor and the rotational speed of the effector is specified for the respective application and the effector. The bevel gear is characterized by low backlash. The combination of the planetary gear in the first gear stage and the bevel gear in the second gear stage has the advantage of achieving the desired transmission ratio with low backlash and high efficiency. Small, compact, and lightweight hand axis motors can be connected directly to the hand axis gear, giving the hand axis a small and compact overall design.

The first planetary gear directly connected to the first hand axis motor has a transmission ratio of less than 1. It ensures that the input rotational speed of the first hand axis motor is converted into an output rotational speed that is lower than the input rotational speed. This results in a gear reduction. The rotational speed of the first hand axis motor is reduced. The planetary gear has the advantage that it takes up little space due to its small volume and that the input shaft and output shaft, also known as the drive shaft and driven shaft, are coaxial.

The bevel gear of the second gear stage is primarily used for deflection. The input and output shafts are at an angle to each other. Their geometric axes have a common intersection point. The bevel gear comprises a crown wheel and a bevel gear pinion, which are arranged with as little play as possible. The range of motion in which the crown wheel and bevel gear pinion can move relative to each other is set as small as possible in the arrangement. Since the planetary gear serves as the transmission and the bevel gear primarily serves as the deflection, the crown wheel and bevel gear pinion can be small in size. This ensures a compact overall design. The bevel gear has significantly less play than the planetary gear. It can reduce the backlash of the planetary gear. This makes the bevel gear particularly well suited for transmitting the torque of the hand axis motor to the effector mounted on the effector holder. Due to the low backlash, the movement of the effector is very precise. This also applies when forces act on the effector at the point of use.

The combination of the planetary gear in the first gear stage, which serves as a gear reduction, and the bevel gear in the second gear stage, which serves as a deflection, achieves a precise drive with the gear reduction specified by the planetary gear with low backlash, particularly low reverse backlash, low friction, low mass, and compact dimensions.

The industrial robot according to the invention has at least one hand axis with a hand axis gear comprising a planetary gear and a bevel gear. If the industrial robot is equipped with several hand axes, only one hand axis or two hand axes or all three hand axes can be designed according to the invention. In an industrial robot with six axes, the 5th axis and the 6th axis are preferably designed according to the invention and thus have a hand axis gear with a planetary gear as the first gear stage and a bevel gear as the second gear stage. If the industrial robot is equipped with two hand axes with a hand axis gear in accordance with the invention, the geometric axes of the hand axis motor, the geometric axes of the first gear stage, and/or the geometric axes of the second gear stage of the two hand axes are preferably aligned at a certain angle to each other. In order to be able to distinguish between these two hand axes constructed according to the invention, they are referred to as the first hand axis and the second hand axis. This is not intended to be a restriction to a specific hand axis of an industrial robot. The hand axis motor of the first hand axis is referred to below as the first hand axis motor. Furthermore, the hand axis gear of the first hand axis is referred to as the first hand axis gear. The planetary gear of the first hand axis is referred to as the first planetary gear and the bevel gear of the first hand axis as the first bevel gear.

According to an advantageous embodiment of the invention, the industrial robot is equipped with at least two hand axes, each of the two hand axes having a hand axis motor and a hand axis gear, and each hand axis gear being equipped with a first gear stage comprising a planetary gear and a second gear stage comprising a bevel gear. As indicated above, one hand axis is referred to as the first hand axis and the other hand axis as the second hand axis. The first hand axis moves the effector about a first geometric axis. The second hand axis moves the effector about a second geometric axis, whereby the second geometric axis being different from the first geometric axis. The planetary gear of the second hand axis is referred to as the second planetary gear. It has a transmission ratio between the input rotational speed and the output rotational speed that is less than 1. The bevel gear of the second hand axis is referred to as the second bevel gear. Reference is made to the above-mentioned features and advantages of the first and second gear stages of the first hand axis.

According to a further advantageous embodiment of the invention, the industrial robot has six axes: three axes of the at least one robot arm and a fourth, fifth, and sixth axis. The fifth axis corresponds to the first hand axis according to the invention and the sixth axis corresponds to the second hand axis according to the invention.

According to a further advantageous embodiment, the first gear stage of the first hand axis is formed exclusively by the first planetary gear.

According to a further advantageous embodiment, the second gear stage of the first hand axis is formed exclusively by the first bevel gear.

According to a further advantageous embodiment of the invention, the first gear stage of the second hand axis is formed exclusively by the second planetary gear.

According to a further advantageous embodiment of the invention, the second geometric axis about which the second hand axis moves the effector is perpendicular to the first geometric axis about which the first hand axis moves the effector.

According to a further advantageous embodiment of the invention, the first hand axis motor has a first drive shaft which is driven for rotation about a first geometric drive shaft axis.

According to a further advantageous embodiment of the invention, the first geometric drive shaft axis is perpendicular to the first geometric axis.

According to a further advantageous embodiment of the invention, the second hand axis motor has a second drive shaft which is driven for rotation about a second geometric drive shaft axis.

According to a further advantageous embodiment of the invention, the second geometric drive shaft axis is parallel to the second geometric axis.

According to a further advantageous embodiment of the invention, the first geometric drive shaft axis and the second geometric drive shaft axis are parallel. In this case, the first hand axis motor and the second hand axis motor can be arranged directly next to each other. This supports a small and compact design.

According to a further advantageous embodiment of the invention, the first bevel gear has a first bevel gear pinion and a first crown wheel connected to the first bevel gear pinion.

According to a further advantageous embodiment of the invention, the second bevel gear has a second bevel gear pinion and a second crown wheel connected to the second bevel gear pinion.

According to a further advantageous embodiment of the invention, the first planetary gear is connected on the drive side directly to the first drive shaft of the first hand axis motor. There is thus no further gear component between the first drive shaft and the first planetary gear.

According to a further advantageous embodiment of the invention, the first planetary gear is connected on the output side directly to the first bevel gear pinion of the first bevel gear. There is thus no further gear component between the first planetary gear and the first bevel gear.

According to a further advantageous embodiment of the invention, the second planetary gear is connected on the drive side directly to the second drive shaft of the second hand axis motor. There is thus no further gear component between the second drive shaft and the second planetary gear.

According to a further advantageous embodiment of the invention, the second planetary gear is connected on the output side directly to the second bevel gear pinion of the second bevel gear. There is thus no further gear component between the second planetary gear and the second bevel gear.

According to a further advantageous embodiment of the invention, the first crown wheel is rotatable about a first geometric crown wheel axis and the second crown wheel is rotatable about a second geometric crown wheel axis. The first geometric crown wheel axis coincides with the second geometric crown wheel axis or is parallel to it.

According to a further advantageous embodiment of the invention, the first hand axis has a hand member which is rotatably arranged about the first geometric axis. Furthermore, the effector holder is rotatably mounted on the hand member about the second geometric axis. The hand member and the effector holder are arranged at least in sections between the first and second crown wheels. This arrangement enables a space-saving and compact design.

According to a further advantageous embodiment of the invention, a first geometric planetary gear axis, about which the first planetary gear is driven by the first hand axis motor, coincides with or is parallel to the first geometric drive shaft axis.

According to a further advantageous embodiment of the invention, a second geometric planetary gear axis, about which the second planetary gear is driven by the second hand axis motor, coincides with or is parallel to the second geometric drive shaft axis.

According to a further advantageous embodiment of the invention, the backlash of the first bevel gear is less than one angular minute. If the industrial robot is designed for high-precision applications, the backlash of the first bevel gear is less than 0.3 angular minutes.

According to a further advantageous embodiment of the invention, the backlash of the second bevel gear is less than one angular minute. In industrial robots for special applications, the backlash of the second bevel gear is less than 0.3 angular minutes.

According to a further advantageous embodiment of the invention, the transmission ratio of the first bevel gear is 1. The input rotational speed of the bevel gear thus corresponds to the output rotational speed of the bevel gear. In this case, the first bevel gear is solely responsible for redirecting the torque. The same applies to the second bevel gear.

According to a further advantageous embodiment of the invention, the first bevel gear provides a gear reduction. The input rotational speed is thus greater than the output rotational speed. This ensures that the play of the first planetary gear in the second gear stage is reduced in accordance with the transmission ratio. In this case, the first hand axis gear has even lower play and higher rigidity. The same applies in the case of gear reduction by the second bevel gear.

According to a further advantageous embodiment of the invention, the industrial robot has serial kinematics with a robot arm provided with a swing arm movably arranged on the robot base and with an arm extension movably arranged on the swing arm. All hand axes are arranged on the arm extension.

According to a further advantageous embodiment of the invention, the industrial robot is provided with parallel kinematics with at least two robot arms, one end of which is connected to the robot base and the other end of which is connected to a tool carrier receiving the effector holder. All hand axes are accommodated on the tool carrier.

Further advantages and advantageous embodiments of the invention are apparent from the claims.

### DRAWING

The drawing shows two embodiments of the invention. It shows:

FIG. 1 First embodiment of an industrial robot in perspective view,

FIG. 2 Side view of the hand axis unit arranged on the industrial robot according to FIG. 1,

FIG. 3 Cross-section through the hand axis unit according to FIG. 2 along the plane marked A-A in FIG. 2,

FIG. 4 Cross-section according to FIG. 3, showing only the first hand axis,

FIG. 5 Cross-section according to FIG. 3, showing only the second hand axis,

FIG. 6 First hand axis gear of the industrial robot according to FIG. 1 in a side view,

FIG. 7 First hand axis gear of the industrial robot according to FIG. 1 in a top view,

FIG. 8 Second embodiment of an industrial robot in perspective view.

### DESCRIPTION OF THE EMBODIMENTS

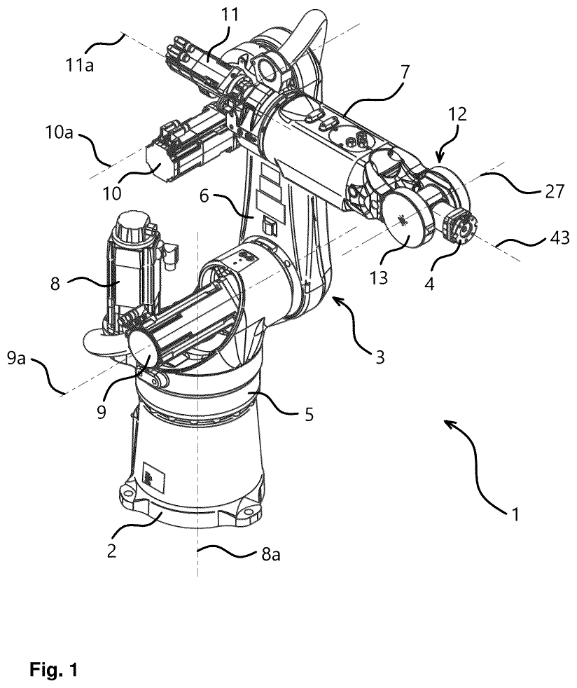

FIGS. 1 to 7 show a first embodiment of an industrial robot. FIG. 1 shows an industrial robot 1 designed as an articulated arm robot. It has a robot base 2, a robot arm 3, and an effector holder 4. The robot arm 3 is equipped with a carousel 5, a swing arm 6, and an arm extension 7. The carousel 5 is rotatably mounted on the robot base 2 and is driven by a carousel motor 8 for rotation about a geometric carousel axis 8a. The swing arm 6 is driven by a swing arm motor 9 for rotation about a geometric swing arm axis 9a relative to the carousel 5. The arm extension 7 is pivotably arranged on the swing arm 6 and is moved relative to the swing arm 6 about a geometric arm extension axis 10a by means of an arm extension motor 10. The effector holder 4 is arranged at the end of the arm extension 7 facing away from the swing arm 6, on which an effector not shown in the drawing can be arranged. The robot arm 3 with the carousel motor 8, the swing motor 9, and the arm extension motor 10 moves the effector holder 4 relative to the robot base 2 in relation to the three geometric axes 8a, 9a, and 10a in space. The geometric axes 8a, 9a, and 10a are mathematical straight lines. They are shown as dashed lines in FIG. 1.

In order to move an effector, which may be arranged on the effector holder 4, relative to three further axes, the industrial robot is equipped with three hand axes: a 4. axis, a 5. axis, and a 6. axis. The 4. axis is equipped with a motor 11. The 5. axis is referred to below as the first hand axis. The 6. axis is referred to below as the second hand axis. The first hand axis and the second hand axis form a hand axis unit 12, which is rotatably mounted on the arm extension 7. The motor 11 of the 4. axis moves the hand axis unit 12 relative to the arm extension 7 about a geometric hand axis unit axis 11a, which extends as a straight line through the arm extension 7. The first hand axis of the hand axis unit 12 moves the effector holder 4 about a first geometric axis 27. The second hand axis of the hand axis unit 12 produces a rotation about a second geometric axis 43.

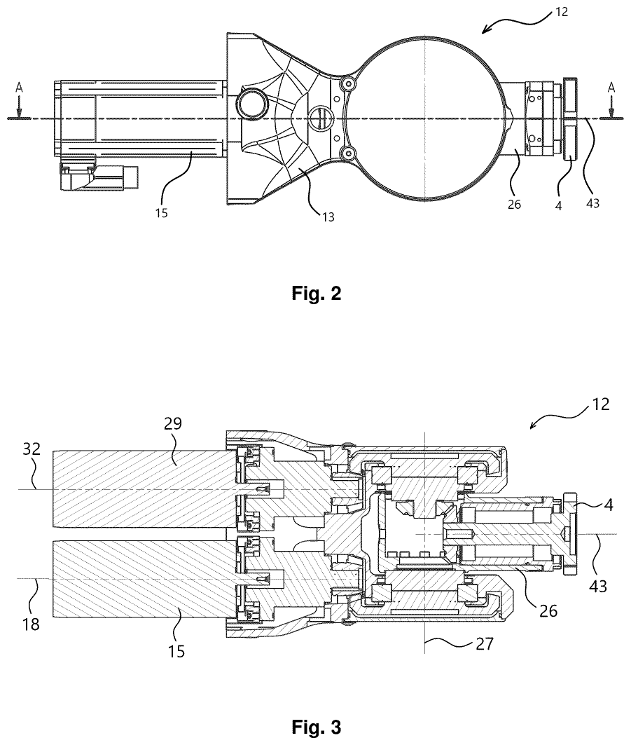

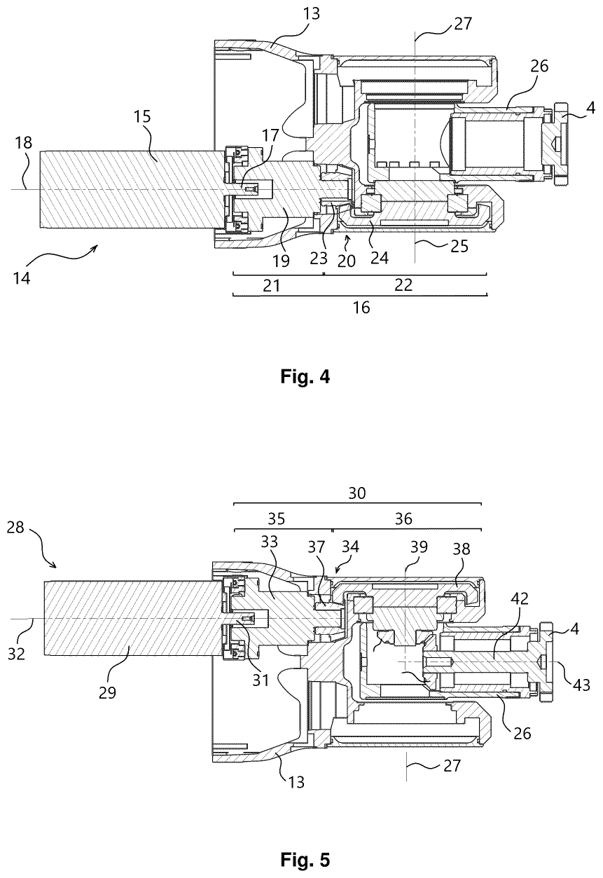

FIG. 2 shows the hand axis unit 12 in a side view. FIG. 3 shows the hand axis unit 12 in cross-section. FIGS. 4, 5, 6, and 7 show details of the hand axis unit 12. The hand axis unit 12 is equipped with a housing 13. The first hand axis 14 and the second hand axis 28 are housed in this housing 13. The first hand axis 14 comprises a first hand axis motor 15 and a first hand axis gear 16. The first hand axis motor 15 drives a first drive shaft 17 for rotation about a first geometric drive shaft axis 18. The first hand axis gear 16 comprises a first planetary gear 19 and a first bevel gear 20. The first planetary gear 19 forms a first gear stage 21 of the first hand axis gear 16. The first bevel gear 20 forms a second gear stage 22 of the first hand axis gear 16. The first planetary gear 19 is coupled directly to the first drive shaft 17 on the drive side, so that the torque of the first drive shaft 17 is transmitted to the first planetary gear 19. The first planetary gear provides a gear reduction. The first bevel gear 20 comprises a first bevel gear pinion 23 and a first crown wheel 24. The first planetary gear 19 is connected directly to the first bevel gear pinion 23 on the output side. The first bevel gear pinion 23 is in operative engagement with the first crown wheel 24. The first planetary gear 19 and the first bevel gear pinion 23 are driven by the first hand axis motor for rotation about the first geometric drive shaft axis 18. The first crown wheel 24 is driven for rotation about a first geometric crown wheel axis 25. The first geometric drive shaft axis 18 and the first geometric crown wheel axis 25 are at an angle to each other. They form an angle of 90°. The first bevel gear 20 ensures that the torque is deflected. The first crown wheel 24 is connected to a hand member 26 and transmits the torque to this hand member 26. The hand member is designed as a hollow body. The effector holder 4 is rotatably mounted in the hand member 26. The geometric axis around which the hand member 26 is driven for rotation by the first hand axis motor 15 and the first hand axis gear 16 is the first geometric axis 27, about which the first hand axis 14 moves an effector arranged on the effector holder. The first geometric axis 27 coincides with the first geometric plate axis 25.

The second hand axis 28 comprises a second hand axis motor 29 and a second hand axis gear 30. The second hand axis motor 29 drives a second drive shaft 31 for rotation about a second geometric drive shaft axis 32. The second hand axis gear 30 comprises a second planetary gear 33 and a second bevel gear 34. The second planetary gear 33 forms a first gear stage 35 of the second hand axis gear 30. The second bevel gear 34 forms a second gear stage 36 of the second hand axis gear 30. The second planetary gear provides a gear reduction. The second planetary gear 33 is coupled directly to the second drive shaft 31 on the drive side, so that the torque of the second drive shaft 31 is transmitted to the second planetary gear 33. The second bevel gear 34 comprises a second bevel gear pinion 37 and a second crown wheel 38. The second planetary gear 33 is connected directly to the second bevel gear pinion 37 on the output side. The second bevel gear pinion 37 is in operative engagement with the second crown wheel 38. The second planetary gear 33 and the second bevel gear pinion 37 are driven by the second hand axis motor 29 for rotation about the second geometric drive shaft axis 32. The second crown wheel 38 is driven for rotation about a second geometric crown wheel axis 39. The second geometric drive shaft axis 32 and the second geometric crown wheel axis 39 are at an angle to each other. They form an angle of 90°. The second bevel gear 34 ensures that the torque is deflected. Via two further bevel gears 40, 41, the torque is transmitted to a shaft 42 of the effector holder 4, which is rotatably mounted in the hand member 26. The effector holder 4 is driven for rotation about a second geometric axis 43. This second geometric axis 43 runs perpendicular to the first geometric axis 27. Furthermore, the second geometric axis 43 runs perpendicular to the second geometric crown wheel axis 39.

In the embodiment, the first hand axis motor 15 and the second hand axis motor 29 are identical in construction. Likewise, the first hand axis gear 16 and the second hand axis gear 30 are identical in construction with respect to the first and second planetary gears 19, 23 and with respect to the first and second bevel gears 20, 34 with a first and second bevel gear pinion 23, 37 and a first and second crown wheel 24, 38.

The first hand axis motor 15 and the second hand axis motor 29 are arranged on the housing 13 in such a way that the first geometric drive shaft axis 18 and the second geometric drive shaft axis 32 are parallel.

The first hand axis motor 15 and the second hand axis motor 29 are housed in a housing of the arm extension 7. Since the first hand axis motor 15 and the second hand axis motor 29 are arranged next to each other, they take up particularly little space in the arm extension. The small dimensions are further favored by the parallel alignment of the first geometric drive shaft axis 18 and the second geometric drive shaft axis 32.

Furthermore, the first crown wheel 24 and the second crown wheel 38 are arranged on the housing 13 in such a way that the first geometric crown wheel axis 25 coincides with the second geometric crown wheel axis 39. The hand member 26 is rotatably mounted between the first crown wheel 24 and the second crown wheel 38 on the housing 13. In order for the housing 13 to enclose the first crown wheel 24 and the second crown wheel 38, it has the characteristic appearance shown in FIG. 1 and FIG. 2.

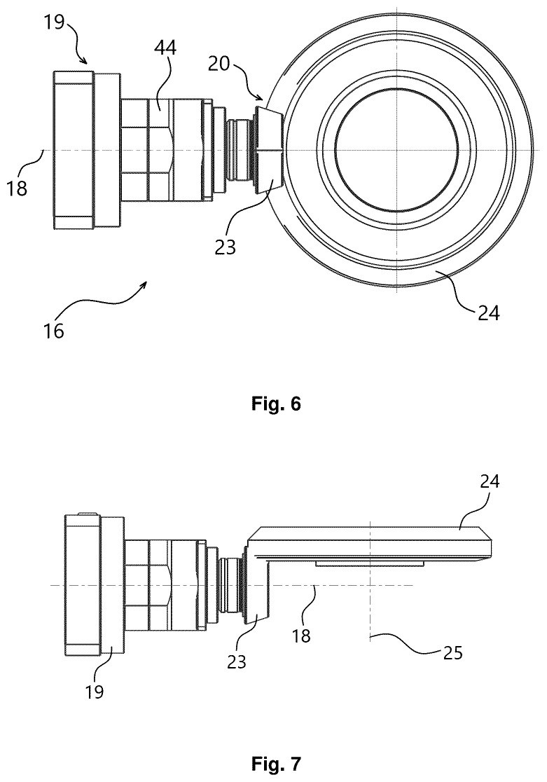

FIGS. 6 and 7 show the first hand axis gear 16 with the first planetary gear 19 and the first bevel gear 20 in a view from above and from the side. The first planetary gear 19 is housed in a planetary gear housing 44 so that the individual components of the first planetary gear are not visible. The first bevel gear pinion 23 of the first bevel gear 20 is arranged directly on the output side of the first planetary gear 19. The first crown wheel 24 of the first bevel gear 20 is in operative engagement with the first bevel gear pinion 23. For simplicity, the toothing of the first bevel gear pinion 23 and the first crown wheel 24 is not shown in FIG. 4. The first planetary gear 19 forms the first gear stage 21 of the first hand axis. This is directly connected to the first hand axis motor, which is not shown in FIG. 4 for simplicity. The first gear stage does not include any other gear parts apart from the first planetary gear 19. The first gear stage 21 of the first hand axis is formed exclusively by the first planetary gear 19. The second gear stage 22 of the first hand axis is formed exclusively by the first bevel gear 20. The first planetary gear is driven by the first hand axis motor, which is not shown in FIG. 4, about a first geometric planetary gear axis. This coincides with the first geometric drive shaft axis 18 of the first hand axis motor. The first crown wheel 24 is driven for rotation about a first geometric crown wheel axis 25. The first geometric crown wheel axis runs perpendicular to the first geometric drive shaft axis 18 and intersects it. The second planetary gear and the second bevel gear are constructed accordingly.

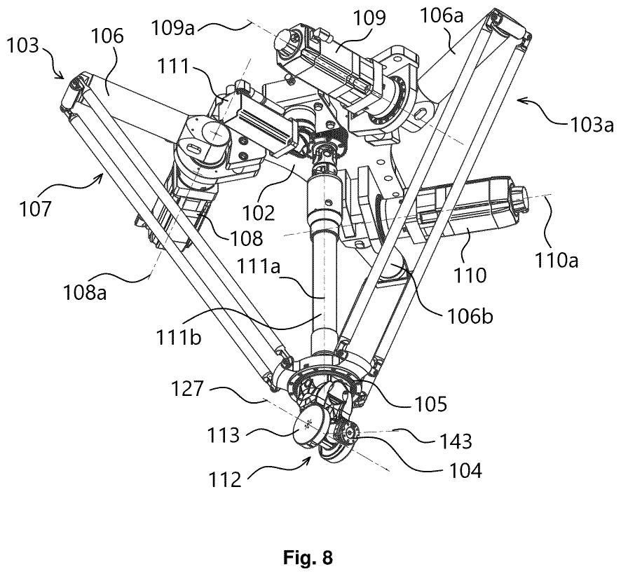

FIG. 8 shows a second embodiment of an industrial robot 101. In contrast to the industrial robot 1 according to the first embodiment, the industrial robot 101 has parallel kinematics. It is equipped with a robot base 102, a tool carrier 105, and three robot arms 103, 103a. Of these three robot arms, the two robot arms 103 and 103a facing the viewer are clearly visible in FIG. 1. The third robot arm is partially concealed. The robot arm motor and the upper arm of this third robot arm are visible.

Each of the three robot arms 103, 103a is essentially of the same design. It comprises a robot arm motor 108, 109, 110 attached to the robot base 102, which drives an upper arm 106, 106a, 106b for rotation about a geometric axis 108a, 109a, 110a of the associated robot arm motor. At the end facing away from the robot arm motor 108, 109, 110, the upper arm 106, 106a, 106b is rotatably connected to two lower arm struts 107. These in turn are rotatably mounted with their other end on the tool carrier 105. The three geometric axes 108a, 109a, 110a of the three robot arm motors 108, 109, 110 lie in one plane. The angle between each pair of these geometric axes 108a, 109a, 110a of the robot arm motors 108, 109, 110 is 60°. The lower arm struts 107 of the three robot arms 103, 103a are also mounted on the tool carrier 105, each offset by 60°.

A further motor 111 is arranged on the robot base 102, which drives a fourth axis equipped with a telescopic tube 111b for rotation about a geometric fourth axis 111a. The telescopic tube 111b is connected to the motor 111 by a first cardan joint and is mounted on the tool carrier 105 by a second cardan joint.

A hand axis unit 112 is arranged on the tool carrier 105, which essentially corresponds to the hand axis unit 12 of FIGS. 1 to 7. The hand axis unit 112 is connected to the fourth axis in such a way that rotation of the telescopic tube 111b about the geometric axis 111a is transmitted to the hand axis unit 112. A first hand axis and a second hand axis corresponding to FIGS. 3 to 7 are accommodated in the housing 113. The first hand axis generates a rotational movement around a first geometric axis 127. The second hand axis generates a rotational movement around a second geometric axis 143, which is perpendicular to the first geometric axis 127. The movements of all axes are transferred to an effector not shown in the drawing, which is mounted on the effector holder 104.

All features of the invention may be essential to the invention, either individually or in any combination with one another.

Reference numbers

| | |
|---|---|
| 1 | Industrial robot |
| 2 | Robot base |
| 3 | Robot arm |
| 4 | Effector holder |
| 5 | Carousel |
| 6 | Swing arm |
| 7 | Arm extension |
| 8 | Carousel motor |
| 8a | Geometric carousel axis |
| 9 | Swing motor |
| 9a | Geometric swing axis |
| 10 | Arm extension motor |
| 10 | Geometric arm extension axis |
| 11 | Motor of the 4th axis |
| 11 | Fourth geometric axis |
| 12 | Hand axis unit |
| 13 | Housing of the hand axis unit |
| 14 | First hand axis |
| 15 | First hand axis motor |
| 16 | First hand axis gear |
| 17 | First drive shaft |
| 18 | First geometric drive shaft axis |
| 19 | First planetary gear |
| 20 | First bevel gear |
| 21 | First gear stage |
| 22 | Second gear stage |
| 23 | First bevel gear pinion |
| 24 | First crown wheel |
| 25 | First geometric bevel gear axis |
| 26 | Hand member |
| 27 | First geometric axis |
| 28 | Second hand axis |
| 29 | Second hand axis motor |
| 30 | Second hand axis gear |
| 31 | Second drive shaft |
| 32 | Second geometric drive shaft axis |
| 33 | Second planetary gear |
| 34 | Second bevel gear |
| 35 | First gear stage |
| 36 | Second gear stage |
| 37 | Second bevel gear pinion |
| 38 | Second crown wheel |
| 39 | Second geometric crown wheel axis |
| 40 | Bevel gear |
| 41 | Bevel gear |
| 42 | Shaft |
| 43 | Second geometric axis |
| 44 | Planetary gear housing |
| 101 | Industrial robot |
| 102 | Robot base |
| 103 | Robot arm |
| 103a | Robot arm |
| 104 | Effector holder |
| 105 | Tool carrier |
| 106 | Upper arm |
| 106a | Upper arm |
| 106b | Upper arm |
| 107 | Lower arm strut |
| 108 | First robot arm motor |
| 108 | Geometric axis of the first robot arm motor |
| 109 | Second robot arm motor |
| 109 | Geometric axis of the second robot arm motor |
| 110 | Third robot arm motor |
| 110a | Geometric axis of the third robot arm motor |
| 111 | Motor of the 4th axis |
| 111a | Geometric 4th axis |
| 111b | Telescopic tube |
| 112 | Hand axis unit |
| 113 | Housing of the hand axis unit |
| 127 | First geometric axis |
| 143 | Second geometric axis |

1. An industrial robot with serial or parallel kinematics,
comprising a robot base (2, 102), at least one robot arm (3, 103, 103a) with arm drive and an effector holder (4, 104) receiving an effector,
wherein the at least one robot arm (3, 103, 103a) is designed to move the effector holder (4, 104) relative to the robot base (2, 102) in at least two dimensions in space, with at least one first hand axis (14) which moves an effector arranged on the effector holder (4, 104) with respect to a first geometric axis (27, 127),
wherein the first hand axis (14) comprises a first hand axis motor (15) and a first hand axis gear (16),
wherein the first hand axis gear (16) has a first gear stage (21) coupled to the first hand axis motor (15), which comprises a first planetary gear (19) whose transmission ratio of input speed to output speed is less than 1,
wherein the first hand axis gear (16) has a second gear stage (22) coupled to the first gear stage (21), which comprises a first bevel gear (20).

2. The industrial robot according to claim 1, wherein the first hand axis motor (15) has a first drive shaft (17) which is driven for rotation about a first geometric drive shaft axis (18).

3. The industrial robot according to claim 2, wherein a first geometric planetary gear axis, about which the first planetary gear (19) is driven by the first hand axis motor (15), coincides with or is parallel to the first geometric drive shaft axis (18).

4. The industrial robot according to claim 2, wherein the first geometric drive shaft axis (18) is perpendicular to the first geometric axis (27, 127).

5. The industrial robot according to claim 2, wherein the first planetary gear (19) is connected on the drive side to the first drive shaft (17) of the first hand axis motor (15).

6. The industrial robot according to claim 1, wherein the first bevel gear (20) has a first bevel gear pinion (23) and a first crown wheel (24) operatively connected to the first bevel gear pinion (23).

7. The industrial robot according to claim 6, wherein the first planetary gear (19) is connected on the output side directly to the first bevel gear pinion (23) of the first bevel gear (20).

8. The industrial robot according to claim 1, further comprising a second hand axis (28) which moves the effector arranged on the effector holder (4, 104) with respect to a second geometric axis (43, 143) which is different from the first geometric axis (27, 127), wherein the second hand axis (28) comprises a second hand axis motor (29) and a second hand axis gear (30), wherein the second hand axis gear (30) has a first gear stage (35) coupled to the second hand axis motor (29), which comprises a second planetary gear (33) whose transmission ratio of incoming speed to outgoing speed is less than 1, and wherein the second hand axis gear (30) has a second gear stage (36) coupled to the first gear stage (35), which comprises a second bevel gear (34).

9. The industrial robot according to claim 8, wherein the second geometric axis (43, 143) is perpendicular to the first geometric axis (27, 127).

10. The industrial robot according to claim 8, wherein the second hand axis motor (29) has a second drive shaft (31) which is driven for rotation about a second geometric drive shaft axis (32).

11. The industrial robot according to claim 10, wherein the second geometric drive shaft axis (32) is parallel to the second geometric axis (43, 143).

12. The industrial robot according to claim 10, wherein the first geometric drive shaft axis (18) and the second geometric drive shaft axis (32) are parallel.

13. The industrial robot according to claim 10, wherein a second geometric planetary gear axis, about which the second planetary gear (33) is driven by the second hand axis motor (29), coincides with or is parallel to the second geometric drive shaft axis (32).

14. The industrial robot according to claim 10, wherein the second planetary gear (33) is connected on the drive side to the second drive shaft (31) of the second hand axis motor (29).

15. The industrial robot according to claim 8, wherein the second bevel gear (34) has a second bevel gear pinion (37) and a second crown wheel (38) operatively connected to the second bevel gear pinion (37).

16. The industrial robot according to claim 15, wherein the second planetary gear (33) is connected on the output side directly to the second bevel gear pinion (37) of the second bevel gear (34).

17. The industrial robot according to claim 15, wherein the first crown wheel (24) is rotatable about a first geometric crown wheel axis (25) and the second crown wheel (38) is rotatable about a second geometric crown wheel axis (39), and wherein the first geometric crown wheel axis (25) coincides with or is parallel to the second geometric crown wheel axis (39).

18. The industrial robot according to claim 17, wherein the first hand axis has a hand member (26) which is rotatably arranged about the first geometric axis (27, 127), wherein the effector holder (4) is rotatably mounted on the hand member (26) about the second geometric axis (43, 143), and wherein the hand member (26) and the effector holder (4, 104) are arranged at least in sections between the first crown wheel (24) and the second crown wheel (38).

19. The industrial robot according to claim 1, wherein the backlash of the first bevel gear (20) is less than one angular minute.

20. The industrial robot according to claim 8, wherein the backlash of the second bevel gear (34) is less than one angular minute.

21. The industrial robot according to claim 1, wherein the industrial robot has a serial kinematic system with a robot arm (3) provided with a swing arm (6) movably arranged on the robot base (2) and with an arm extension (7) movably arranged on the swing arm (6), and wherein all hand axes (11, 14, 28) are arranged on the arm extension (7).

22. The industrial robot according to claim 1, comprising parallel kinematics with at least two robot arms (103, 103a), one end of which is connected to the robot base (102) and the other end of which is connected to a tool carrier (105) receiving the effector holder (104), that wherein all hand axes (112) are accommodated on the tool carrier (105).
